(19) United States
(12) Patent Application Publication
(10) Pub. No.: US 2020/0067105 A1
(43) Pub. Date: Feb. 27, 2020

(54) ELECTRODE CATALYST FOR FUEL CELLS AND METHOD OF MANUFACTURING THE SAME

(71) Applicant: HYUNDAI MOBIS Co., Ltd., Seoul (KR)

(72) Inventors: Dae Jong YOU, Yongin-si (KR); Sung Chul LEE, Yongin-si (KR)

(21) Appl. No.: 16/355,845

(22) Filed: Mar. 18, 2019

(30) Foreign Application Priority Data
Aug. 23, 2018 (KR) 10-2018-0098720

(51) Int. Cl. H01M 4/86; H01M 4/92

(52) U.S. Cl. CPC H01M 4/8657; H01M 4/925; H01M 4/923

(57) ABSTRACT

Provided is an electrode catalyst for fuel cells. The electrode catalyst for fuel cells includes a core including an alloy of platinum, copper, and metal oxide and a shell including platinum or a platinum alloy material.

### CROSS-REFERENCE TO RELATED APPLICATION

This application claims priority from and the benefit of Korean Patent Application No. 10-2018-0098720, filed on Aug. 23, 2018, which is hereby incorporated by reference for all purposes as if set forth herein.

### BACKGROUND

### Field

Exemplary embodiments relate to an electrode catalyst for fuel cells.

### Discussion of the Background

Fuel cells may be categorized into polymer electrolyte membrane fuel cells (PEMFCs), direct methanol fuel cells (DMFCs), phosphoric acid fuel cells (PAFCs), molten carbonate fuel cells (MCFCs), and solid oxide fuel cells (SOFCs), based on the kinds of electrolytes and fuels.

In the PEMFCs, hydrogen is used as fuel at a low temperature (for example, less than 100° C.), and electrical energy is generated through an electrochemical reaction between oxygen included in air and hydrogen. Such fuel cells generate water (H₂O) as byproducts in an electrochemical reaction process, and thus, may be referred to as ecofriendly energy.

Fuel cells include an anode where fuel is oxidized, a cathode where oxygen is reduced, and an electrolyte.

Hydrogen used as fuel is oxidized in the anode to generate a hydrogen ion (H⁺) and an electron, the electron generated in the anode generates energy through an external conductive wire, and the hydrogen ion moves to the cathode through the electrolyte. In the cathode, oxygen (O₂) supplied from air reacts with the hydrogen ion transferred through the electrolyte from the anode to generate water (H₂O).

In order to increase an activity of an oxygen reduction reaction (ORR), a platinum (Pt)-based electrode catalyst which is commonly stable and is good in ORR is used as an element of each of the anode and the cathode.

As well known, Pt is an element of an expensive precious metal. Therefore, it is required to decrease the amount of Pt applied to the Pt-based electrode catalyst, for reducing the cost caused by the mass production of fuel cells.

Recently, research on a Pt-based alloy catalyst including Pt and a low-cost transition metal is being actively performed for decreasing the amount of used Pt and increasing the activity of the ORR.

When a transition metal is on a particle surface of the Pt-based alloy catalyst, an electrochemical durability of the Pt-based alloy catalyst is reduced. Therefore, in the related art, a process of inserting the transition metal of the particle surface of the Pt-based alloy catalyst into an internal Pt particle is performed through a thermal treatment process or a process (a dealloying process) of melting the transition metal of the particle surface of the Pt-based alloy catalyst with an acid solution.

However, the dealloying process increases a surface roughness of the Pt-based alloy catalyst, causing the reduction in durability of the Pt-based alloy catalyst. Also, the thermal treatment process increases a particle size of the Pt-based alloy catalyst, causing the reduction in activity of the ORR.

The above information disclosed in this Background section is only for enhancement of understanding of the background of the invention and, therefore, it may contain information that does not constitute prior art.

### SUMMARY

Exemplary embodiments of the present invention provide an electrode catalyst for fuel cells, which is good in durability and activity of an oxygen reduction reaction (ORR), an electrode for fuel cells, which includes the electrode catalyst, an fuel cell, and a method of manufacturing the electrode catalyst.

In one general aspect, an electrode catalyst for fuel cells include: a core including an alloy including platinum (Pt) represented by Chemical Formula 1, a transition metal, and metal oxide; and an active particle including a shell including Pt,

PtMₐC_{b} [Chemical Formula 1]

In Chemical Formula 1, M denotes the transition metal, C denotes the metal oxide, a range of a is approximately 0.33<a≤1.0, and a range of b is approximately 0.25≤b≤1.0.

In another general aspect, an electrode catalyst for fuel cells includes: a cathode electrode; an anode electrode disposed opposite to the cathode electrode; and an electrolyte film disposed between the cathode electrode and the anode electrode, wherein at least one of the cathode and the anode includes the electrode catalyst for fuel cells.

In another general aspect, a method of manufacturing an electrode catalyst for fuel cells includes: mixing a platinum (Pt) precursor, a solvent, and a pre-catalyst including Pt, a transition metal, and metal oxide to obtain an electrode catalyst composition; performing thermal treatment on the electrode catalyst composition to perform a galvanic replacement reaction, and replacing a transition metal and metal oxide, which are on a surface of a core including Pt, a transition metal, and metal oxide, with Pt obtained from the Pt precursor to obtain an alloy catalyst including the core and a shell including Pt, based on the galvanic replacement reaction; and performing thermal treatment on the alloy catalyst with hydrogen to obtain an electrode catalyst for fuel cells, in which a surface of the alloy catalyst is activated.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A is a diagram schematically illustrating an electrode catalyst for fuel cells according to an embodiment of the present invention.

FIG. 1B is a diagram schematically illustrating a cross-sectional structure of the electrode catalyst for fuel cells illustrated in FIG. 1A.

FIGS. 2, 3, and 4 are diagrams showing results of analysis performed on electrode catalysts manufactured according to an embodiment and comparative examples 1 and 2 by using a high-resolution transmission electron microscopy (HR-TEM).

FIG. 5 is a diagram showing a result of TEM-EDX line scanning element analysis performed on an electrode catalyst manufactured according to an embodiment.

FIG. 6 is a diagram showing an oxygen reduction reaction (ORR) characteristic of an electrode including each of electrode catalysts according to an embodiment and comparative examples 1 and 2.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

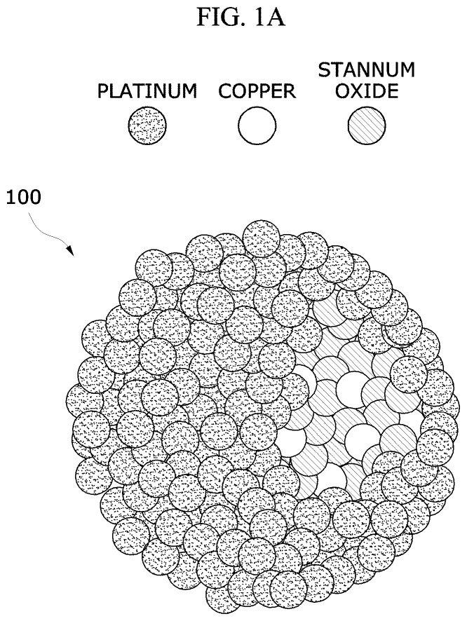

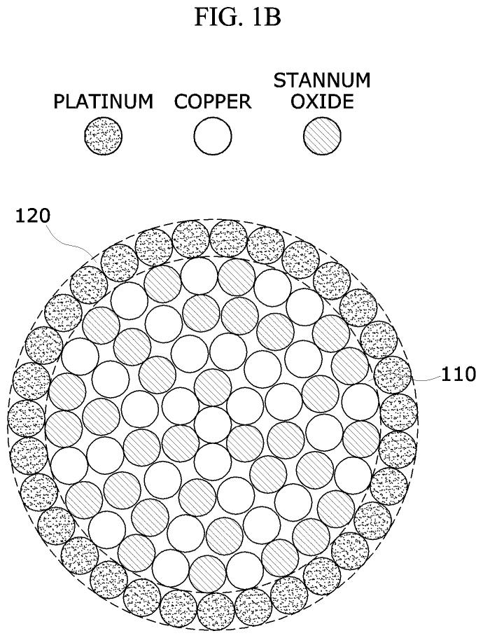

FIG. 1A is a diagram schematically illustrating an electrode catalyst 100 for fuel cells according to an embodiment of the present invention. FIG. 1B is a diagram schematically illustrating a cross-sectional structure of the electrode catalyst 100 for fuel cells illustrated in FIG. 1A.

Referring to FIGS. 1A and 1B, the electrode catalyst 100 for fuel cells according to an embodiment of the present invention may fundamentally be a platinum (Pt)-based catalyst and may include an active particle having a core-shell structure.

The active particle including the core-shell structure may include a core 110 which includes an alloy of Pt, a transition metal, and metal oxide and a shell 120 which includes Pt or a Pt alloy material and is provided on a surface of the core 110.

The transition metal included in the core 110 may perform an electronic reaction with Pt to change an electronic environment of the electrode catalyst 100, thereby increasing an activity of an oxygen reduction reaction (ORR).

When the core 110 is configured with an alloy including a transition metal, a transition metal which is on a surface of the core 110 decreases an electrochemical durability of the electrode catalyst 100, and thus, it is required to remove the transition metal which is on the surface of the core 110.

Therefore, as described in the background, the transition metal which is on the surface of the core 110 may be melted by using an acid solution, and in this case, the transition metal is dissolved in a process of melting the transition metal with the acid solution, causing the reduction in activity of the electrode catalyst 100.

The shell 120 provided on the surface of the core 110 may prevent the transition metal from being dissolved by a reaction with the acid solution. That is, the shell 120 may protect the transition metal and the metal oxide to effectively prevent the dissolution of the transition metal, thereby increasing a durability of the electrode catalyst 100.

The transition oxide included in the core 110 may decrease growth of a metal particle to decrease a size of the metal particle. Therefore, a non-surface area of the electrode catalyst 100 may increase, and thus, an activity of the ORR may increase.

Therefore, the electrode catalyst 100 for fuel cells according to an embodiment of the present invention may prevent the transition metal from being dissolved by a reaction with the acid solution, and the non-surface area of the electrode catalyst 100 may increase, thereby increasing an activity of the ORR.

The core 110 according to an embodiment of the present invention may be represented by the following Chemical Formula 1.

PtMaCb [Chemical Formula 1]

In Chemical Formula 1, M may denote a transition metal, and for example, may be one of cobalt (Co), iron (Fe), nickel (Ni), and copper (Cu). In the present embodiment, M may be Cu.

In Chemical Formula 1, C may denote metal oxide, and for example, may be one material selected from among InO₂, SnO₂, Sb₂O₃, and TeO₂. In the present embodiment, C may be SnO₂.

In Chemical Formula 1, a and b may respectively denote a content (mole) of M and a content (mole) of C with respect to Pt of 1 mole.

A range of a may be approximately 0.33<a≤1.0, and a range of b may be approximately 0.25≤b≤1.0. In such a range, an activity of an ORR of the electrode catalyst 100 may increase.

The core 110 may have a structure where Pt—Cu, Pt(Cu—SnO₂), and Pt—SnO₂ are bonded to one another. In this case, a stability of each of the transition metal “Cu” and the metal oxide “SnO₂” may be enhanced, and a lattice strain may occur, thereby increasing an activity of the ORR.

The transition metal “M” may decrease oxygen bonding energy of a catalyst surface, and the metal oxide “C” may decrease a size of a particle, thereby increasing an activity of the ORR.

A Pt precursor, a transition metal precursor, and a metal oxide precursor may be used to manufacture the core 110.

The Pt precursor may be a compound of one or more materials of H₂PtCl₆, H₂PtCl₄, K₂PtCl₆, K₂PtCl₄, and PtCl₂(NH₃)₄.

The transition metal precursor may be a compound of one or more materials of Cu precursor-containing nitride, chloride, sulfide, acetate, acetylacetonate, cyanide, and CuCl₂.2H₂O, but is not limited thereto.

The metal oxide precursor may be a compound of one or more materials of stannum or Tin (Sn) precursor-containing oxide, Sn precursor-containing nitride, Sn precursor-containing chloride, Sn precursor-containing sulfide, Sn precursor-containing acetate, Sn precursor-containing acetylacetonate, and Sn precursor-containing cyanide, but is not limited thereto.

The shell 120 may be represented by the following Chemical Formula 2.

PtNc [Chemical Formula 2]

In Chemical Formula 2, N may denote gold (Au), iridium (Ir), or rhodium (Rh).

In Chemical Formula 2, c may denote a content (mole) of N per 1 mole, and a range thereof may be 0≤c≤1.

In a range of c, dissolution of a transition metal and oxide may be more effectively prevented when N reacts with an acid solution. Accordingly, durability may be enhanced, and an oxygen reaction caused by an electronegativity difference between an internal core and an external shell may be reduced, thereby increasing the activity of the ORR.

In the core 110, a content of Cu—Sn oxide with respect to Pt may be approximately 43.3 to 96.6 parts by weight with respect to total 100 parts by weight of Pt.

When a content of Cu—Sn oxide is equal to or lower than 43.3 parts by weight, a content of Cu for increasing an activity of Pt may be insufficient, and due to this, a chemical activity may be reduced. In this case, also, a content of Sn oxide for enhancing the dispersibility of carbon may be insufficient, and due to this, catalyst particles may agglutinate, causing the reduction in activity and durability.

When a content of Cu—Sn oxide is higher than 96.6 parts by weight, the amount of Cu may increase, and due to this, Cu may be exposed at a surface of the electrode catalyst. For this reason, dissolution may occur in the surface of the electrode catalyst, and the amount of Sn oxide which is on the surface of the electrode catalyst may increase, causing the reduction in activity.

In Cu—Sn oxide, a content of Sn oxide with respect to Cu may be approximately 25 to 100 parts by weight with respect to total 100 parts by weight of Cu.

When a content of Sn oxide is equal to or lower than 25 parts by weight, a particle size of Pt—Cu may increase, and the dispersibility of carbon may be reduced. When a content of Sn oxide is higher than 100 parts by weight, a content of Sn oxide may be high, and due to this, the increase in activity of the ORR may be hindered.

A content of the shell 120 with respect to the core 110 may be approximately 5 to 25 parts by weight with respect to total 100 parts by weight of the core 110.

When a content of the shell 120 is equal to or lower than 5 parts by weight, a thickness of a shell which is on a surface of the core 110 may be thin, and due to this, electrochemical corrosion of Cu and Sn oxide included in the internal core may occur.

When a content of the shell 120 is higher than 25 parts by weight, a thickness of the shell which is on the surface of the core 110 may be thick, and due to this, an oxygen bonding force of Cu and Sn oxide included in the internal core may not be reduced, causing the reduction in performance.

When the core 110 includes an alloy of Pt, Cu, and Sn oxide, a portion of each of Pt, Cu, and Sn oxide which is on the surface of the core 110 may be replaced with Pt included in the shell 120, the electrode catalyst 100 may be formed in a core-shell structure which includes a core including an alloy of Pt, Cu, and Sn oxide and a shell including Pt.

In this manner, when the electrode catalyst 100 has the core-shell structure, the amount of used Pt which is expensive may be reduced. In order to enhance an ORR of Pt which is an electrode catalyst, an electrical metal which is low in electronegativity may be alloyed for chemically increasing an electronegativity of Pt. In another method, the ORR of Pt may be non-superficially enhanced by physically reducing a particle of Pt. Also, a method of chemically enhancing performance may be applied to Cu of the internal core, and a method of physically enhancing performance may be applied to Sn oxide.

Moreover, the core-shell structure may protect Cu—Sn oxide by using a Pt layer, thereby enhancing durability.

Hereinafter, a method of manufacturing an electrode catalyst for fuel cells will be described.

First, a process of mixing a Pt precursor, a solvent, and a pre-catalyst including Pt, Cu, and Sn oxide to obtain an electrode catalyst composition may be performed. A carbon-based carrier may be added to the electrode catalyst composition. When the carbon-based carrier is added to the electrode catalyst composition, the dispersibility of particles included in the pre-catalyst may be enhanced.

Subsequently, a galvanic replacement reaction may be performed by performing thermal treatment on the electrode catalyst composition, and based on the galvanic replacement reaction, a process of replacing a transition metal (Cu) and metal oxide (Sn oxide), which are on a surface of a core including Pt, a transition metal, and metal oxide, with Pt obtained from the Pt precursor to obtain an alloy catalyst including the core and a shell including Pt may be performed. Here, a galvanic replacement reaction temperature may be within a range of approximately 90° C. to 170° C. When the galvanic replacement reaction temperature is within a range of approximately 90° C. to 170° C., the reactivity of the galvanic replacement reaction may be good.

Subsequently, a process of performing thermal treatment on the alloy catalyst with hydrogen to obtain an electrode catalyst for fuel cells, in which a surface of the alloy catalyst is activated, may be performed.

In the process of obtaining the electrode catalyst composition, the pre-catalyst may be manufactured through the following process.

First, a process of mixing a Pt precursor, a Cu precursor, a Sn oxide precursor, and a solvent to prepare a metal precursor compound may be performed.

The metal precursor compound may be a metal stabilizer, and citric acid, ethylenediaminetetraacetic acid (EDTA), sodium citrate, and NaOH may be further mixed with the metal precursor compound.

Subsequently, a process of inserting the metal precursor compound into an autoclave reactor to perform a reduction reaction on the metal precursor compound at a high temperature and high pressure may be performed.

Subsequently, a process of filtering, washing, and drying a reduction reaction resultant material based on the reduction reaction to obtain the pre-catalyst may be performed.

A reaction temperature of the autoclave reactor may be approximately 160° C. to 300° C., and pressure of the autoclave reactor may be approximately 400 psi or less, and for example, may be 50 psi to 200 psi.

By replacing the Pt precursor, the Cu precursor, and the Sn oxide precursor in a range of the reaction temperature and a range of the pressure, a uniform alloy particle may be produced, and when the carbon-based carrier is added to the metal precursor compound, the dispersibility of particles included in the pre-catalyst may be enhanced.

In a process of preparing the metal precursor compound, the solvent may use a glycol-based solvent, such as ethylene glycol, 1,2-propylene glycol, 1,3-butanediol, 1,4-butanediol, neopentyl glycol, diethylene glycol, 3-methyl-1,5-pentandiol, 1,6-hexandiol, or trimethylol propane, or an alcohol-based solvent such as methanol, ethanol, isopropyl alcohol, or butanol, but is not limited thereto.

A content of the solvent may be approximately 1,000 to 4,000 parts by weight with respect to total 100 parts by weight of the Pt precursor, the transition metal precursor, and the metal oxide precursor. In such a range of the solvent, a uniform alloy particle may be produced in replacing precursors included in the electrode catalyst composition.

In the reduction reaction, a microwave may be used as a heat source, and the kind of a heat source for increasing a temperature of the autoclave reactor is not limited.

An output power of the microwave may be 800 W to 1,700 W. When the output power of the microwave is within a range of 800 W to 1,700 W, a uniform alloy particle may be produced in replacing the Pt precursor, the transition metal precursor, and the metal oxide precursor. Also, a microwave irradiation time may vary based on a condition such as the output power of the microwave, and for example, may be 30 minutes to 1 hour (in detail, 10 minutes to 30 minutes).

When the microwave is used as a heat source for the reduction reaction, manufacturing equipment may be simple, and a reaction time may be short.

### Embodiment: Manufacturing Electrode Catalyst

VC (vulcan-black, 250 m²/g) of 0.75 g may be dispersed in a compound of ethylene glycol of 300 g and water of 300 g by using an ultrasonic wave, thereby preparing a carbon-based carrier compound.

A metal precursor compound may be prepared by mixing 8 wt % Pt precursor (H₂PtCl₆.6H₂O) of 10.52 g, 8 wt % Cu precursor (CuCl₂.2H₂O) of 5.62 g, 8 wt % Sn oxide precursor (SnCl₂.2H₂O) of 1.53 g, and 10 wt % citric acid of 32.33 g, which are dissolved in water.

An electrode catalyst composition may be prepared by mixing the carbon-based carrier compound with the metal precursor compound, and then, may be stirred for about 30 minutes.

The electrode catalyst composition may be sealed by Teflon and may be inserted into an autoclave reactor, and then, a reduction reaction may be performed on the electrode catalyst composition by irradiating a microwave (a maximum power: 1,700 W) for about 30 minutes to 1 hour to increase a temperature of the autoclave reactor to about 250° C. In this case, pressure of the autoclave reactor may be about 210 psi.

When the reaction ends, a pre-catalyst (PtCuSnO₂/C) may be obtained by filtering and drying the electrode catalyst composition. In the pre-catalyst (PtCuSnO₂/C), a content of PtCuSnO₂ which is an active particle may be about 42.4 parts by weight with respect to total 100 parts by weight (a total weight of the active particle and a carbon-based carrier) of the pre-catalyst.

Separately, a metal precursor compound may be prepared by mixing 8 wt % H₂PtCl₆.6H₂O of 11.57 g and 30 wt % sodium citrate of 19.52 g, which are dissolved in an aqueous solution. The galvanic replacement reaction may be performed by mixing the metal precursor compound of 31.09 g, the pre-catalyst (PtCuSnO₂/C) of 1.455 g, and water of 582.4 g for 10 minutes and stirring a compound at a reaction temperature of approximately 160° C.

When the reaction ends, a reaction resultant material may be filtered, washed, and dried, and then, thermal treatment may be performed at 300° C. in a hydrogen atmosphere, thereby obtaining an electrode catalyst (PtCuSnO₂@Pt/C).

### Comparative Example 1: Manufacturing Electrode Catalyst

Except for that a content of a Cu precursor (CuCl₂.2H₂O) is 7.5 g and an Sn precursor is not used in manufacturing a metal precursor compound, an electrode catalyst (PtCu@Pt/C) may be manufactured in the same method as an embodiment.

### Comparative Example 2: Manufacturing Electrode Catalyst

Except for that a content of an Sn precursor (SnCl₂.2H₂O) is 7.28 g and a Cu precursor is not used in manufacturing a metal precursor compound, an electrode catalyst (PtSnO₂@Pt/C) may be manufactured in the same method as an embodiment.

### Evaluation Example 1: Transmission Electron Microscopy (TEM) Observation

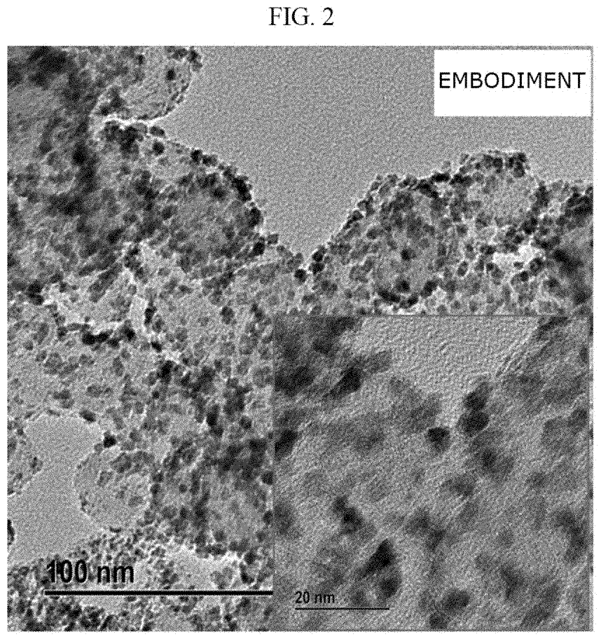

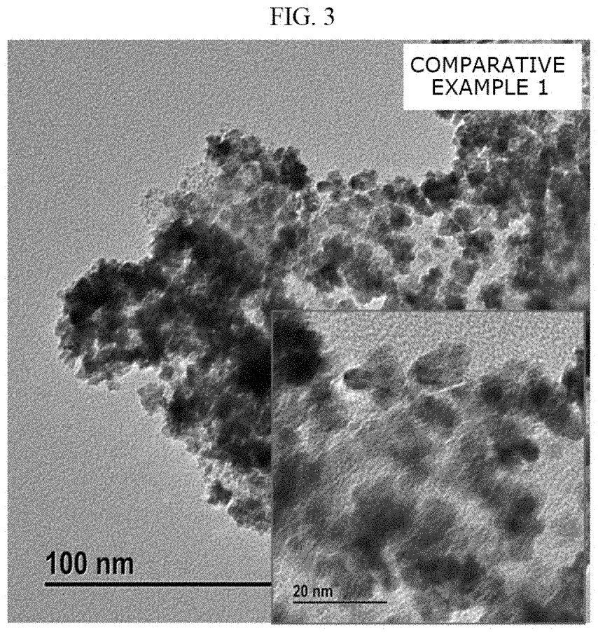

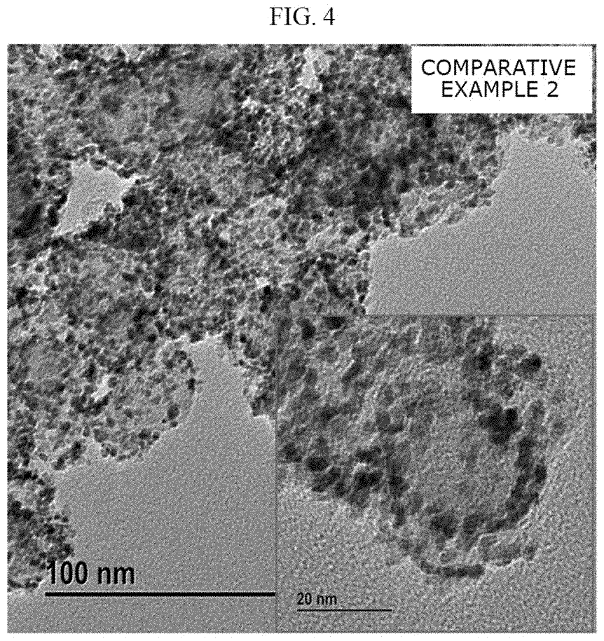

Results, obtained by observing the electrode catalysts manufactured according to an embodiment and the comparative examples 1 and 2 with a high-resolution transmission electron microscopy (HR-TEM), are shown in FIGS. 2 to 4.

Referring to FIGS. 2 to 4, it may be seen that the electrode catalyst including Cu according to the comparative example 1 is low in dispersibility with respect to the carbon-based carrier, but the electrode catalyst including Sn oxide according to an embodiment and the electrode catalyst including Sn oxide according to the comparative example 2 are uniformly dispersed in the carbon-based carrier.

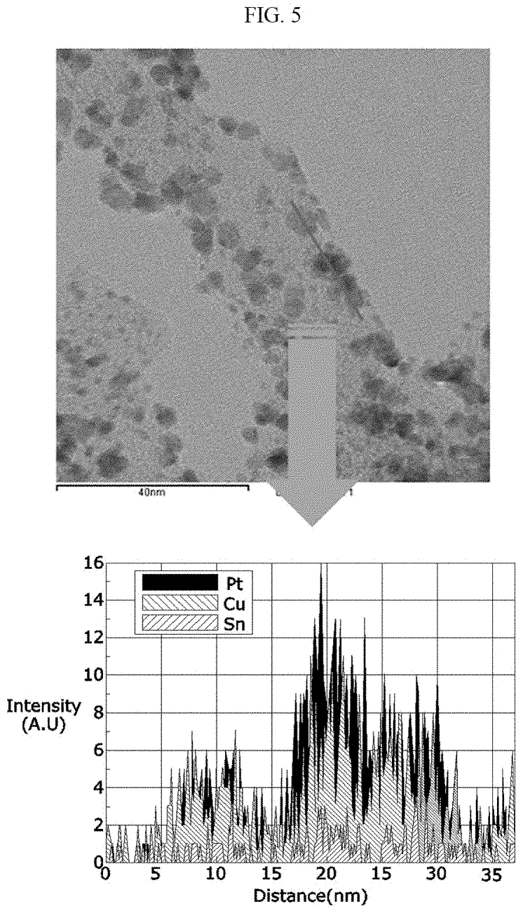

FIG. 5 is a diagram showing a component analysis result obtained by analyzing on the electrode catalyst manufactured according to an embodiment with a TEM-EDX apparatus.

As shown in FIG. 5, the electrode catalyst manufactured according to an embodiment internally includes Cu and Sn and externally has a Pt structure, and thus, it may be seen that the electrode catalyst has the core-shell structure.

### Evaluation Example 2: X-Ray Diffraction (XRD) Analysis

Results obtained by performing X-ray diffraction (XRD) analysis (MP-XRD, Xpert PRO, Philips/Power 3 kW) on the electrode catalysts of an embodiment and the comparative examples 1 and 2 are listed in the following Table 1.

TABLE 1

| Division | Lattice constant | Particle size (nm) |
|---|---|---|
| Comparative example 1 | 3.8767 | 6.82 |
| Embodiment 1 | 3.9033 | 3.12 |
| Comparative example 2 | 3.9173 | 3.02 |

It may be seen through Table 1 that the lattice constant of an embodiment is greater than the comparative example 1 including Cu and is less than the comparative example 2 including Sn oxide. This denotes that, since the electrode catalyst of an embodiment includes Cu for chemically increasing an activity and Sn oxide for physically decreasing a particle, an electrochemical activity increases.

### Evaluation Example 3: ORR Characteristic Evaluation

An ethylene glycol dispersion of a catalyst may obtained by dispersing a catalyst of 0.02 g with ethylene glycol of 10 g, and the ethylene glycol dispersion of 15 μl may be dripped with a micro-pipet in a carbon rotating electrode and may be dried at 80° C., and then, ethylene glycol dispersion of 15 μl of 5 wt % Nafion may be dripped into an electrode into which the catalyst is dripped and may be dried, thereby preparing an electrode.

A working electrode manufactured in the method may be equipped in a rotating to disk electrode (RDE) apparatus, a Pt wire may be prepared as a counter electrode, and Ag/AgCl (KClsat) may be prepared as a reference electrode.

A prepared 3-phase electrode may be inserted into 0.1M HClO₄ electrolyte solution and may be bubbled with nitrogen for 30 minutes, thereby removing oxygen remaining in the electrolyte solution. By using a controlled potential electrolysis apparatus and a controlled current electrolysis apparatus (potentiostat/galvanostat), cyclic voltammetry analysis may be performed within a range of 0.03 V to 1.2 V (vs. NHE), thereby measuring current density values.

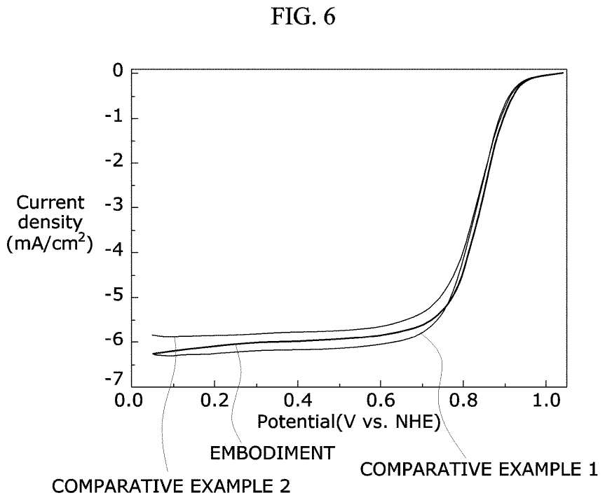

Subsequently, oxygen is dissolved and saturated in an electrolyte solution, and then, an ORR current density is recorded in a negative direction up to a potential (0.5 V to 1.2 V vs. NHE) where a material limit current occurs in an open circuit voltage (OCV) and is shown in FIG. 6. A current density in a potential of about 0.9 V is shown in the following Table 1 and FIG. 6.

TABLE 2

| Kind | Current density(mA/cm² Pt)@0.9 V, 1600 rpm |
|---|---|
| Comparative example 1 | −0.608 |
| Embodiment 1 | −0.946 |
| Comparative example 2 | −0.722 |

It may be confirmed through FIG. 6 and Table 2 that the electrode catalyst manufactured according to an embodiment is better in reactivity of the ORR than the electrode catalysts of the comparative examples 1 and 2. It is estimated that such a result is obtained because Cu included in a core increases an electronegativity of Pt and Sn oxide included in the core increases agglutination and dispersibility.

As described above, the present invention is not limited to the elements and methods according to the above described embodiments, and some or all of the embodiments may be selectively combined and configured in order for the embodiments to be variously modified. For example, the electrode catalyst for fuel cells according to the embodiments of the present invention may include at least one of a cathode electrode and an anode electrode which configure an electrode for fuel cells. In this viewpoint, the electrode catalyst for fuel cells according to the embodiments of the present invention may be applied to a fuel cell which is includes a cathode electrode, an anode electrode disposed opposite to the cathode electrode, and an electrolyte film disposed between the cathode electrode and the anode electrode.

According to the embodiments of the present invention, since the electrode catalyst for fuel cells includes a core including an alloy of Pt, a transition metal, and metal oxide and a shell including Pt or a Pt alloy material, the durability of the electrode catalyst and the activity of the ORR increase.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An electrode catalyst for fuel cells, the electrode catalyst comprising:
a core comprising an alloy represented by Chemical Formula 1, the alloy comprising platinum (Pt), a transition metal, and metal oxide; and
an active particle comprising a shell that comprises Pt,
PtMₐC_{b}; [Chemical Formula 1]
wherein in Chemical Formula 1, M denotes the transition metal, C denotes the metal oxide, a range of a is approximately 0.33<a≤1.0, and a range of b is approximately 0.25≤b≤1.0.

2. The electrode catalyst of claim 1, wherein the transition metal is one material selected from the group consisting of cobalt (Co), iron (Fe), nickel (Ni), and copper (Cu).

3. The electrode catalyst of claim 1, wherein the metal oxide is one material selected from the group consisting of Indium oxide (InO₂), Tin oxide (SnO₂), Antimony oxide (Sb₂O₃), and Tellurium oxide (TeO₂).

4. The electrode catalyst of claim 1, wherein
the transition metal is copper (Cu), and
the metal oxide is Tin oxide (SnO₂).

5. The electrode catalyst of claim 4, wherein, in the core, a content of Cu and SnO₂ with respect to Pt is approximately 43.3 to 96.6 parts by weight with respect to total 100 parts by 3 weight of Pt.

6. The electrode catalyst of claim 4, wherein, in the core, a content of the SnO₂ with respect to Cu is approximately 25 to 100 parts by weight with respect to total 100 parts by weight of Cu.

7. The electrode catalyst of claim 1, wherein a content of the shell with respect to the core is approximately 5 to 25 parts by weight with respect to total 100 parts by weight of the core.

8. An electrode catalyst for fuel cells, the electrode catalyst comprising:
a cathode electrode;
an anode electrode disposed opposite to the cathode electrode; and
an electrolyte film disposed between the cathode electrode and the anode electrode,
wherein at least one of the cathode electrode and the anode electrode comprises:
a core including an alloy represented by Chemical Formula 1, the alloy comprises platinum (Pt, a transition metal, and metal oxide; and
an active particle comprising a shell that comprises Pt,
PtMₐC_{b}; [Chemical Formula 1]
in Chemical Formula 1, M denotes the transition metal, C denotes the metal oxide, and a range of a is approximately 0.33<a≤1.0, and a range of b is approximately 0.25<b≤1.0.

9. A method of manufacturing an electrode catalyst for fuel cells, the method comprising the steps of:
mixing a platinum (Pt) precursor, a solvent, and a pre-catalyst comprises Pt, a transition metal, and metal oxide to obtain an electrode catalyst composition;
performing thermal treatment on the electrode catalyst composition to perform a galvanic replacement reaction, and replacing a transition metal and metal oxide, which are on a surface of a core comprising Pt, a transition metal, and metal oxide, with Pt obtained from the Pt precursor to obtain an alloy catalyst comprises the core and a shell with Pt, based on the galvanic replacement reaction; and
performing thermal treatment on the alloy catalyst with hydrogen to obtain an electrode catalyst for fuel cells, a surface of the alloy catalyst is activated in the electrode catalyst.

10. The method of claim 9, wherein a temperature of the galvanic replacement reaction is approximately 90° C. to 200° C.

11. The method of claim 9, further comprising, before the step of obtaining of the electrode catalyst composition, the step of obtaining the pre-catalyst,
wherein the step of obtaining of the pre-catalyst further comprises
mixing a Pt precursor, a transition metal precursor, a metal oxide precursor, and a solvent to prepare a metal precursor compound;
inserting the metal precursor compound into an autoclave reactor to perform a reduction reaction on the metal precursor compound; and
filtering, washing, and drying a reduction reaction resultant material based on the reduction reaction to obtain the pre-catalyst.

12. The method of claim 11, wherein the metal oxide precursor is a compound of one or more materials of Tin (Sn) precursor-containing oxide, Sn precursor-containing nitride, Sn precursor-containing chloride, Sn precursor-containing sulfide, Sn precursor-containing acetate, Sn precursor-containing acetylacetonate, and Sn precursor-containing cyanide.

13. The method of claim 11, wherein
a reaction temperature of the autoclave reactor is approximately 160° C. to 300° C., and
pressure of the autoclave reactor is approximately 50 psi to 200 psi.

14. The method of claim 11, wherein, in the obtaining of the electrode catalyst composition, a content of the solvent is approximately 1,000 to 4,000 parts by weight with respect to total 100 parts by weight of the Pt precursor, the transition metal precursor, and the metal oxide precursor.
